(19) United States
(12) Patent Application Publication
(10) Pub. No.: US 2009/0230863 A1
(43) Pub. Date: Sep. 17, 2009

(54) Plasma Display Panel

(76) Inventor: Seiki Kurogi, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/065,298

(22) PCT Filed: Aug. 31, 2005
(86) PCT No.: PCT/JP2005/015920

§ 371 Date: Feb. 29, 2008

(51) Int. Cl. H01J 17/49

(52) U.S. Cl. 313/584

(57) ABSTRACT

The cell pitch of a non-effective display area is made smaller than the cell pitch of an effective display area so that the non-effective display area is made narrower.

A plasma display panel includes a pair of substrates arranged face to face to each other, and a plurality of electrodes formed on the inner face of one of the substrates so as to extend in a fixed direction so that a surface discharge is generated between the adjacent electrodes to form a display screen. The display screen has an effective display area formed in a center portion of the screen and a non-effective display area formed adjacent to the effective display area outside the effective display area. The pitch of the electrodes of the non-effective display area is made smaller than the pitch of the electrodes of the effective display area.

### TECHNICAL FIELD

The present invention relates to a plasma display panel (PDP), and more specifically relates to an electrode structure for a surface-discharge-type PDP. In recent years, a plasma display panel has come to provide a television display because of developments in colored image display, and has drawn public attention as the most prospective candidate for a device that can achieve a large-size flat panel display.

### BACKGROUND ART

A three-electrode surface-discharge-type PDP of an AC-drive type has been known as a conventional PDP. This PDP has a structure in which a number of display electrodes capable of surface discharging are provided on an inner face of one of substrates (for example, a substrate on a front face side or a display face side) in a horizontal direction and a number of address electrodes for use in selecting light-emitting cells are provided on an inner face of the other substrate (for example, the substrate on a back face side) in a direction intersecting with the direction of the display electrodes so that each of intersections between the display electrodes and the address electrodes forms one cell (unit light-emitting area). One pixel is configured by three cells, that is, a red (R) cell, a green (G) cell and a blue (B) cell.

The display electrodes on the substrate on the front face side are covered with a dielectric layer. The address electrodes on the substrate on the back face side are also covered with a dielectric layer, with a barrier rib being formed between the address electrodes, and each of R-use, G-use and B-use phosphor layers is formed between the barrier ribs separating respective areas corresponding to the R cell, G cell and B cell.

The PDP is manufactured by processes in which, with the substrate on the front face side and the substrate on the back face side, thus prepared, being arranged face to face to each other, a peripheral portion is sealed, and a discharge gas is then sealed inside thereof (see Patent Document 1). Patent Document 1: Japanese Published Unexamined Patent Application No. HEI 10(1998)-241571

### DISCLOSURE OF THE INVENTION

### Problems to be Solved by the Invention

The surface-discharge-type PDP of this kind has a cell structure in which an effective display area is formed in the center portion of the screen and a non-effective display area is formed on the adjacent peripheral portion of the effective display area. This non-effective display area is placed so as to allow peripheral cells of the effective display area to stably operate discharging. The non-effective display area is directly connected to a width of a frame (box frame) serving as a set unit. In recent years, there have been demands for making the width of the box frame as narrow as possible, and for this reason, the non-effective display area has to be made as narrow as possible.

The present invention has been devised to satisfy these demands, and its object is to make a cell pitch of the non-effective display area smaller than the cell pitch of the effective display area so that the non-effective display area is made narrower.

### Means to Solve the Problems

The present invention provides a plasma display panel comprising: a pair of substrates arranged face to face to each other; and a plurality of electrodes formed on the inner face of at least one of the substrates so as to extend in a fixed direction so that a surface discharge is generated between the adjacent electrodes to form a display screen, wherein the display screen has an effective display area formed in a center portion of the screen and a non-effective display area formed adjacent to the effective display area outside the effective display area, and the pitch of the electrodes of the non-effective display area is made smaller than the pitch of the electrodes of the effective display area.

### EFFECTS OF THE INVENTION

In accordance with the present invention, the non-effective display area can be made as small as possible, while the discharge of the peripheral cells of the effective display area is maintained in a stable manner.

### BRIEF DESCRIPTION OF THE DRAWINGS

FIG. 1 is an explanatory view that shows a structure of a PDP in accordance with the present invention.

FIG. 2 is an explanatory view that shows a state of the PDP on the plan view.

FIG. 3 is an explanatory view that shows a discharging state of the PDP of FIG. 2.

FIG. 4 shows a comparative example that indicates an electrode structure in which the cell pitch of a non-effective display area is equal to the cell pitch of an effective display area.

FIG. 5 shows a comparative example that indicates an electrode structure in which the cell pitch of a non-effective display area is equal to the cell pitch of an effective display area.

### DESCRIPTION OF REFERENCE NUMERALS

11 Substrate on front face side
12 Transparent electrode
13 Bus electrode
17, 24 Dielectric layer
19 Protective film
21 Substrate on back face side
28R, 28G, 28B Phosphor layer
29 Barrier rib
A Address electrode
L Display line
X, Y Display electrode

### BEST MODE FOR CARRYING OUT THE INVENTION

In the present invention, examples of the paired substrates include a substrate made from glass, quartz, ceramics or the like, and such a substrate on which desired components, such as electrodes, an insulating film, a dielectric layer and a protective film, are formed.

The electrodes are designed so as to have a structure in which a plurality of electrodes are formed on an inner face of one of the substrates so as to extend in a fixed direction. Thus, the adjacent electrodes are allowed to generate a surface discharge between the adjacent electrodes to carry out a screen display. The electrodes can be formed by using various publicly known materials and methods in the corresponding field. Examples of the materials to be used for the electrodes include a transparent conductive material, such as ITO and SnO₂, and a metal conductive material, such as Ag, Au, Al, Cu and Cr. Various publicly known methods in the corresponding field may be adopted as the method for forming the electrodes. For example, a thick-film forming technique, such as printing, may be used, or a thin-film forming technique, such as a physical deposition method or a chemical deposition method, may be used. With respect to the thick-film forming technique, for example, a screen-printing method is used. With respect to the physical deposition method of the thin-film forming technique, a vapor deposition method and a sputtering method may be used. With respect to the chemical deposition method, a thermal CVD method, a photo CVD method, or a plasma CVD method may be used.

In the present invention, the display screen is provided with an effective display area formed in the center portion of the screen and a non-effective display area formed adjacent to the effective display area outside of the effective display area. The effective display area refers to an area in which a surface discharge is generated so that an actual screen is displayed, and the non-effective display area refers to an area in which, although a voltage for use in a surface discharge is applied thereto, no surface discharge is generated, with only a black screen being displayed.

The present invention is mainly applied to a plasma display panel which is provided with a pair of substrates that are arranged face to face with each other, a plurality of main electrodes formed on the inner face of one of the substrates so as to extend in a fixed direction and a plurality of address electrodes that are formed on the inner face of the other substrate in a direction perpendicular to the main electrodes, with a surface discharge being generated between the adjacent main electrodes, so that a display screen is formed. In this structure, it is only necessary for the pitch of the main electrodes of the non-effective display area to be made smaller than the pitch of the main electrodes of the effective display area.

In the case of the plasma display panel having the above-mentioned structure, the pitch of the address electrodes of the non-effective display area may be made smaller than the pitch of the address electrodes of the effective display area.

Moreover, another structure may be used in which each of barrier ribs is formed between the address electrodes on the other substrate, and the pitch of the address electrodes of the non-effective display area is made smaller than the pitch of the address electrodes of the effective display area, while the pitch of the barrier ribs of the non-effective display area is made smaller than the pitch of the barrier ribs of the effective display area.

In the case of the plasma display panel having this structure, the width of the main electrodes of the effective display area is preferably made narrower than the width of the main electrodes of the effective display area so that a surface discharge gap between the main electrodes of the non-effective display area is made virtually equal to a surface discharge gap between the main electrodes of the effective display area.

Based upon an embodiment shown in the drawings, the following description will discuss the present invention in detail. However, the present invention is not intended to be limited by this, and various modifications may be made therein.

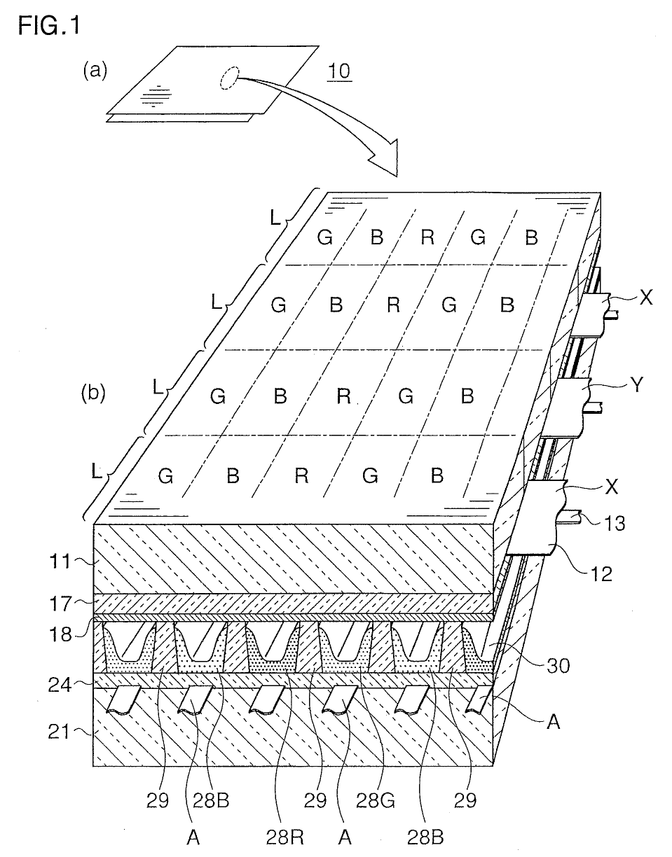

FIGS. 1(a) and 1(b) are explanatory views that show a structure of a PDP in accordance with the present invention. FIG. 1(a) is a general view, and FIG. 1(b) is a partially exploded perspective view thereof. This PDP is a surface-discharge type PDP with three electrodes of AC-drive type used for color display.

A PDP 10 is configured by a substrate 11 on the front face side and a substrate 21 on the back face side. For example, a glass substrate, a quartz substrate, a ceramic substrate or the like may be used as the substrate 11 on the front face side and the substrate 21 on the back face side.

On the inner face of the substrate 11 on the front face side, display electrodes X and display electrodes Y are placed in a horizontal direction with equal intervals. Each of gaps between the adjacent display electrodes X and display electrodes Y forms a display line L. Each of the display electrodes X and Y is configured by a transparent electrode 12, made from ITO, SnO₂ or the like, having a wide width, and a bus electrode 13, made of metal, such as Ag, Au, Al, Cu, and Cr, and a laminated body thereof (for example, a laminated structure of Cr/Cu/Cr), having a narrow width. Upon forming these display electrodes X and Y, a thick-film-forming technique such as a screen-printing process is used for Ag and Au, and a thin-film-forming technique, such as a vapor deposition method and a sputtering method, and an etching technique are used for the other materials so that a desired number of electrodes having desired thickness, width and gap can be formed.

Here, in the present PDP, a PDP having a so-called ALiS structure in which display electrodes X and display electrodes Y are placed with equal intervals, with each gap between the adjacent display electrode X and display electrode Y being allowed to form a display line L, has been exemplified; however, the present invention may also be applied to a PDP having a structure in which paired display electrodes X and Y are placed separately with a distance (non-discharge gap) in which the paired display electrodes X and Y generate no discharge.

On the display electrodes X and Y, an alternating-current (AC) driving dielectric layer 17 is formed so as to cover the display electrodes X and Y. The dielectric layer 17 is formed by processes in which a low-melting-point glass paste is applied onto the substrate 11 on the front face side by using a screen-printing method and fired thereon. The dielectric layer 17 may also be formed by film-forming a SiO₂ film thereon by using a plasma CVD method.

A protective film 18, used for protecting the dielectric film 17 from damage due to collision of ions generated by discharge upon display, is formed on the dielectric layer 17. This protective film is made from MgO or the like. The protective film may be formed by using a known thin-film forming process in the corresponding field, such as an electron beam vapor deposition method and a sputtering method.

On the inner side face of the substrate 21 on the back face side, a plurality of address electrodes A are formed in a direction intersecting with the display electrodes X and Y on the plan view, and a dielectric layer 24 is formed so as to cover the address electrodes A. The address electrodes A, which generate an address discharge used for selecting cells to emit light at intersections with the display electrodes Y, is formed into a three-layer structure of Cr/Cu/Cr. These address electrodes A may also be formed by using another material, such as Ag, Au, Al, Cu and Cr. In the same manner as in the display electrodes X and Y, upon forming these address electrodes A, a thick-film-forming technique such as a screen-printing process is used for Ag and Au, and a thin-film-forming technique, such as a vapor deposition method and a sputtering method, and an etching technique are used for the other materials so that a desired number of electrodes having desired thickness, width and gap can be formed. The dielectric layer 24 can be formed by using the same method and the same material as those of the dielectric layer 17.

A plurality of barrier ribs 29 having a stripe shape are formed on the dielectric layer 24 between the adjacent address electrodes A. Not limited to this shape, the shape of the barrier ribs 29 may have a mesh shape that divides the discharge space for each of the cells. The barrier ribs 29 may be formed by using a method, such as a sand blasting method, a printing method and a photo-etching method. For example, in the sand blasting method, a glass paste, made from a low-melting-point glass flit, a binder resin and a solvent, is applied onto the dielectric layer 24 and dried thereon, and cutting particles are then blasted onto the glass paste layer, with a cutting mask having openings corresponding to the barrier rib pattern being attached thereto, so that the glass paste layer exposed to the openings of the mask is cut off, and this is fired to form the barrier ribs. Moreover, in the photo-etching method, in place of the cutting process by the use of the cutting particles, a photosensitive resin is used as the binder resin, and after exposing and developing processes by the use of a mask, a firing process is carried out thereon to form the barrier ribs.

On the dielectric layer 24, phosphor layers 28R, 28G and 28B corresponding to red (R), green (G) and blue (B) are formed on the side faces of the barrier ribs 29 and the gaps between the barrier ribs. The phosphor layers 28R, 28G and 28B are formed through processes in which a phosphor paste containing phosphor powder, a binder resin and a solvent is applied onto the inside a discharge space having a concave groove shape between the barrier ribs 29 by using a screen-printing method or a method using a dispenser, and after these processes have been repeated for each of the colors, a firing process is carried out. These phosphor layers 28R, 28G and 28B may also be formed through a photolithographic technique by using a sheet-shaped phosphor layer material (so-called green sheet) containing phosphor powder, a photosensitive material and a binder resin. In this case, a sheet having a desired color is affixed onto the entire face of a display area on a substrate, and the sheet is subjected to exposing and developing processes; thus, by repeating these processes for each of the colors, the phosphor layers having the respective colors are formed in the corresponding gaps between the barrier ribs.

The PDP is manufactured through processes in which the substrate 11 on the front face side and the substrate 21 on the back face side are arranged face to face with each other so as to allow the display electrodes X, Y and address electrodes A to intersect with each other, and the peripheral portion thereof is sealed, with a discharge space 30 surrounded by the barrier ribs 29 being filled with a discharge gas formed by mixing Xe and Ne. In this PDP, the discharge space 30 at each of intersections between the display electrodes X and Y and the address electrodes A forms one cell (unit light-emitting area) that is the minimum unit of display. One pixel is configured by three cells of R, G and B.

The displaying process is carried out in the following manner: First, a reset voltage is applied to all the gaps between the display electrodes X and Y so that a reset discharge is generated (this period is generally referred to as a reset period), and the charged state of each cell is thus evenly maintained. Thereafter, a scanning voltage is successively applied to the display electrodes Y, while a voltage is applied to a desired address electrode A, so that a selection discharge is generated at the corresponding intersection between the display electrode Y and the address electrode A; thus, a light-emitting cell is selected (this period is generally referred to as an address period), and by utilizing a wall charge formed on the display electrode Y of the cell following the light emission, a display discharge is generated between the display electrode X and the display electrode Y (this period is generally referred to as a display period). The selection discharge corresponds to an opposing discharge between the address electrode A and the display electrode Y opposite to each other in a longitudinal direction, and the display discharge corresponds to a surface discharge between the display electrodes X and Y that are placed on planes in parallel with each other.

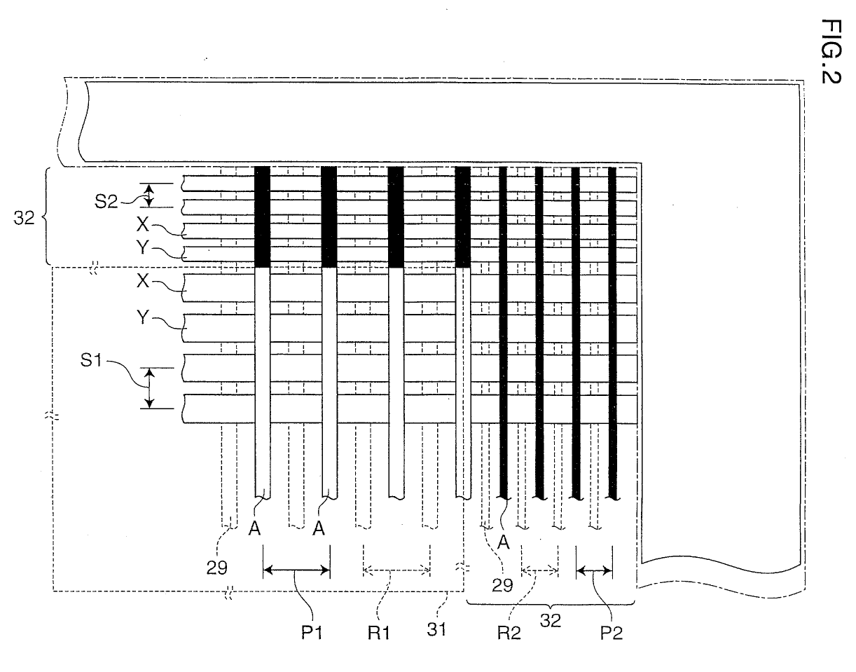

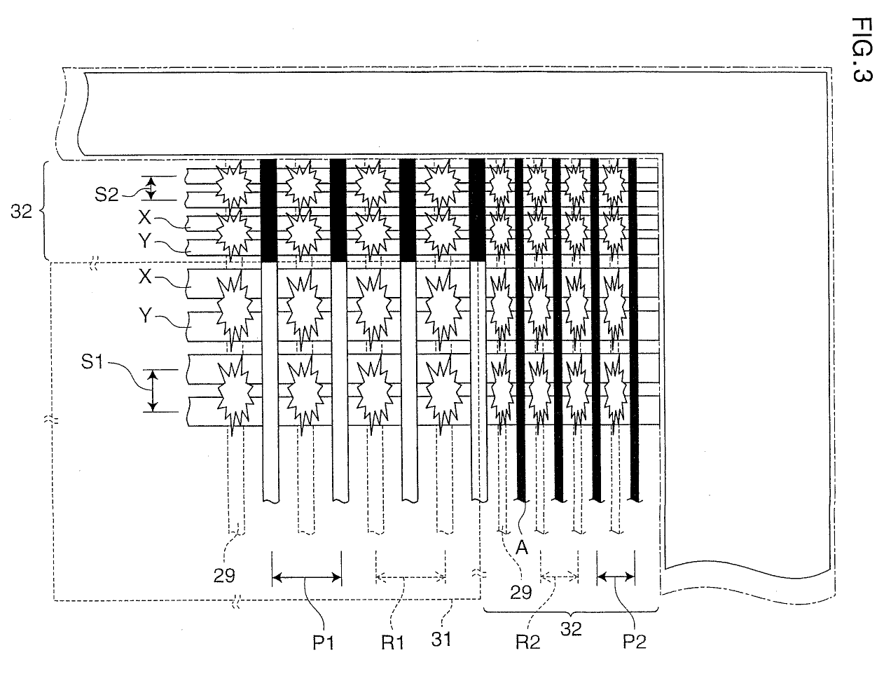

FIG. 2 is an explanatory view that shows the PDP on the plan view, and FIG. 3 is an explanatory view that shows a discharging state of the PDP in FIG. 2.

These Figures indicate an upper right portion of the panel. An effective display area 31 is formed in the center portion of the panel, and outside the effective display area 31, a non-effective display area 32 is placed adjacent to the effective display area 31. The effective display area 31 is indicated by a dotted line. The outer frame of the non-effective display area 32 is indicated by a dashed line. Outside the dashed line of the non-effective display area 32, leading electrode portions of the display electrodes X and Y and the address electrodes A are located; however, these are omitted from the Figures.

As shown in these Figures, in the PDP, the same cells as those of the effective display area 31 are also formed on the non-effective display area 32 so as to stably operate discharging in the peripheral cells of the effective display area 31.

With respect to the cells of the non-effective display area 32, although a scanning voltage is applied to the display electrode Y, no voltage is applied to the address electrode A during the address period, with the result that no selection discharge is generated in the non-effective display area 32. Therefore, in the successive display periods, the cells of the non-effective display area 32 do not emit light, even when a display voltage is applied to the display electrodes X and Y. In this manner, no selection discharge is generated in the cells of the non-effective display area 32 so that a black display is carried out.

Supposing that the pitch of the display electrodes X and Y of the effective display area 31 is S1 and that the pitch of the display electrodes X and Y of the non-effective display area 32 is S2, the relationship between the electrode pitch S1 and the electrode pitch S2 is given by S1>S2.

Moreover, supposing that the pitch of the address electrodes A of the effective display area 31 is P1 and that the pitch of the address electrodes A of the non-effective display area 32 is P2, the relationship between the electrode pitch P1 and the electrode pitch P2 is given by P1>P2.

The pitch of the barrier ribs 29 is the same as the pitch of the address electrodes A, and supposing that the pitch of the barrier ribs 29 of the effective display area 31 is R1 and that the pitch of the barrier ribs 29 of the non-effective display area 32 is R2, the relationship between the barrier rib pitch R1 and the barrier rib pitch R2 is given by R1>R2.

Since the cells of the non-effective display area 32 also emit light by the reset discharge (see FIG. 3), the distance (discharging gap) between the display electrodes X and Y of the non-effective display area 32 is preferably made equal to the discharging gap of the effective display area 31, in order to make the discharging start voltage of the cells of the non-effective display area 32 virtually equal to that of the cells of the effective display area 31.

In order to make the discharging gap of the effective display area 31 equal to the discharging gap of the non-effective display area 32, it is necessary to narrow the electrode width with respect to the display electrodes X and Y of the non-effective display area 32. For this reason, the display electrodes X and Y of the non-effective display area 32 may be configured only by bus electrodes.

With respect to the address electrodes A of the non-effective display area 32, the width of the electrodes is made narrower than that of the address electrodes A of the effective display area 31. With respect to the barrier ribs of the non-effective display area 32 also, the width of the barrier ribs is made narrower than the barrier ribs 29 of the effective display area 31.

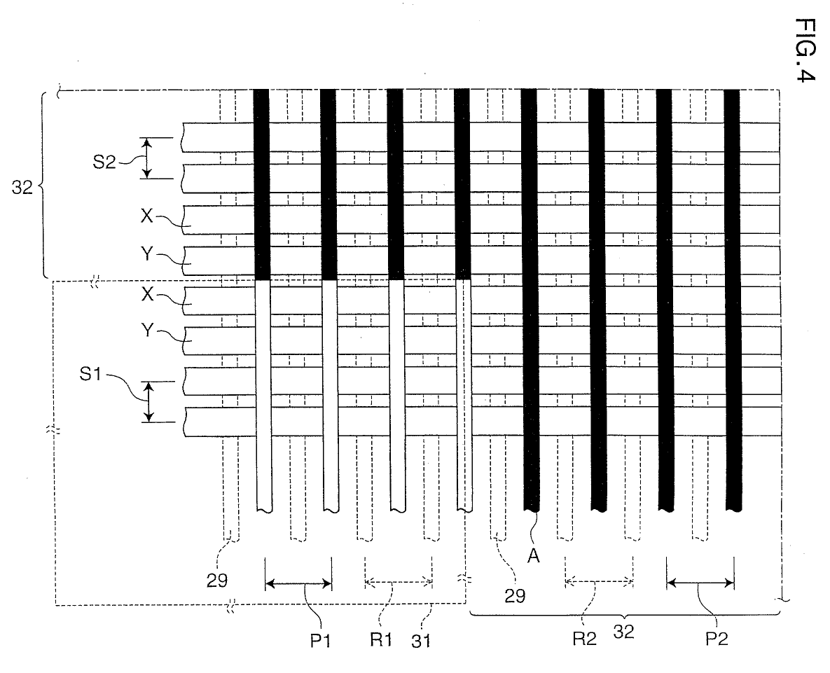

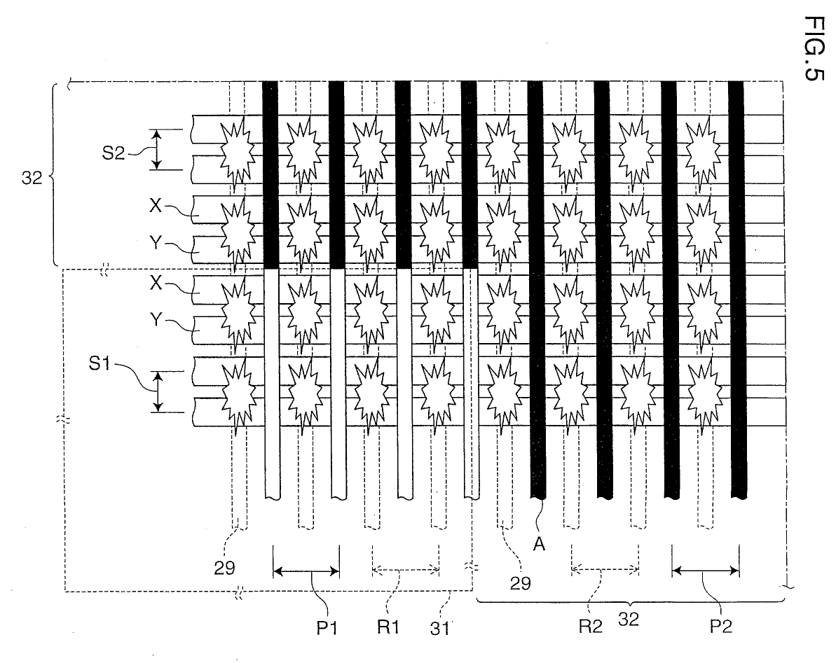

FIGS. 4 and 5 show a comparative example that represents an electrode structure in which the cell pitch of the non-effective display area 32 is equal to the cell pitch of the effective display area 31. FIG. 4 is a view corresponding to FIG. 2, and FIG. 5 is a view corresponding to FIG. 3.

In the electrode structure shown in FIGS. 4 and 5, supposing that the pitch of the display electrodes X and Y of the effective display area 31 is S1 and that the pitch of the display electrodes X and Y of the non-effective display area 32 is S2, the relationship between the electrode pitch S1 and the electrode pitch S2 is given by S1=S2.

Moreover, supposing that the pitch of the address electrodes A of the effective display area 31 is P1 and that the pitch of the address electrodes A of the non-effective display area 32 is P2, the relationship between the electrode pitch P1 and the electrode pitch P2 is given by P1=P2.

The pitch of the barrier ribs 29 is set in the same manner as in the pitch of the address electrodes A, and supposing that the pitch of the barrier ribs 29 of the effective display area 31 is R1 and that the pitch of the barrier ribs 29 of the non-effective display area 32 is R2, the relationship between the barrier rib pitch R1 and the barrier rib pitch R2 is give by R1=R2. In this manner, an electrode structure is made in such a manner that the cell pitch of the non-effective display area 32 is equal to the cell pitch of the effective display area 31.

When FIG. 4 is compared with FIG. 2, the portion with slanting lines is made narrower in FIG. 2. In the same manner, when FIG. 5 is compared with FIG. 3, the portion with slanting lines is made narrower in FIG. 3.

In this manner, the pitch S2 between the display electrodes X and Y and the pitch P2 between the address electrodes A of the non-effective display area 32 are made narrower than the pitch S1 between the display electrodes X and Y and the pitch P1 between the address electrodes A of the effective display area 31. That is, the cell pitch of the non-effective display area 32 is made narrower than the cell pitch of the effective display area 31. Thus, the area of the non-effective display area 32 is made smaller so that the frame of the display panel is consequently made narrower. Even in the case when the cell pitch is made smaller, since the black display is performed on the non-effective display area 32 in the same manner as in the conventional structure, the peripheral cells of the effective display area are allowed to carry out discharging in a stable manner.

1. A plasma display panel comprising:
a pair of substrates arranged face to face to each other; and
a plurality of electrodes formed on the inner face of at least one of the substrates so as to extend in a fixed direction so that a surface discharge is generated between the adjacent electrodes to form a display screen,
wherein the display screen has an effective display area formed in a center portion of the screen and a non-effective display area formed adjacent to the effective display area outside the effective display area, and the pitch of the electrodes of the non-effective display area is made smaller than the pitch of the electrodes of the effective display area.

2. A plasma display panel comprising:
a pair of substrates arranged face to face to each other;
a plurality of main electrodes formed on the inner face of one of the substrates so as to extend in a fixed direction; and
a plurality of address electrodes formed on the inner face of the other substrate in a direction intersecting with the main electrodes, so that a surface discharge is generated between the adjacent main electrodes to form a display screen,
wherein the display screen has an effective display area formed in the center portion of the screen and a non-effective display area formed adjacent to the effective display area outside the effective display area, and the pitch of the main electrodes of the non-effective display area is made smaller than the pitch of the main electrodes of the effective display area.

3. The plasma display panel according to claim 2, wherein the pitch of the address electrodes of the non-effective display area is made smaller than the pitch of the address electrodes of the effective display area.

4. The plasma display panel according to claim 2, wherein each of barrier ribs is formed between the address electrodes on the other substrate, the pitch of the address electrodes of the non-effective display area is made smaller than the pitch of the address electrodes of the effective display area, and the pitch of the barrier ribs of the non-effective display area is made smaller than the pitch of the barrier ribs of the effective display area.

5. The plasma display panel according to claim 2, wherein a width of the main electrodes of the non-effective display area is made narrower than the width of the main electrodes of the effective display area so that a surface discharge gap between the main electrodes of the non-effective display area is made virtually equal to the surface discharge gap between the main electrodes of the effective display area.
